(19) United States
(12) Patent Application Publication
(10) Pub. No.: US 2004/0109511 A1
(43) Pub. Date: Jun. 10, 2004

(54) Output level adjusting circuit and method thereof for multi-carrier transmitter

(75) Inventor: Jae-Hyuk Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/603,596

(22) Filed: Jun. 26, 2003

(30) Foreign Application Priority Data
Dec. 5, 2002 (KR) 77056/2002

(51) Int. Cl. H04K 1/02; H04L 25/03

(52) U.S. Cl. 375/296

(57) ABSTRACT

An output level adjusting circuit for a multi-carrier transmitter includes an ALC (automatic level control) function for controlling a level of a multi-carrier signal output from the transmitter and an AGC (automatic gain control) function for controlling a gain of a multi-carrier signal. The ALC or the AGC operation is selectively performed based on a comparison between a PAR (park to average ratio) of the multi-carrier signal and a target PAR. Based on the selected operation, a level of the multi-carrier signal is adjusted as an input of a power amplifier.

### BACKGROUND OF THE INVENTION

1. Field of the Invention

The present invention relates to a multi-carrier transmitter, and in particular to an adjusting circuit and method for controlling an output level of a multi-carrier signal

2. Background of the Related Art

In a mobile communication system such as a CDMA (code division multiple access system), plural user signals are multiplexed and are transmitted simultaneously in the same frequency or frequency band. In order to restrain diffusion of a signal spectrum, a multiplexed multi-cast signal has to be amplified without distortion in a power amplifier. When the number of multiplexed subscriber signals increases, a peak level of a multi-carrier signal also increases and accordingly an output signal of the power amplifier will inevitably have distortion elements.

It is possible to solve the above problem by increasing a maximum output of the power amplifier. There are, however, drawbacks such as size increase of a transmitter and unnecessary increase of power consumption. Accordingly, a clipping technique for limiting a level of an I (in-phase) signal and a Q (quadrature) signal according to the number of multiplexed signals has been presented.

FIG. 1 is a block diagram illustrating a multi-carrier transmitter disclosed in U.S. Pat. No. 6,044,177 to Hiroyasu Muto. This transmitter includes plural modulators 10a˜10n for dividing an input bit stream into an I signal and a Q signal and limiting a peak level of the I signal and the Q signal; a multiplexing circuit 20 for multiplexing channel signals output from the modulators 10a˜10b; and a power amplifier for amplifying a multi-carrier signal output from the multiplexing circuit 20 and outputting it to an antenna. The plural modulators 10a˜10n have the same construction and only the modulator 10a will be described for convenience.

Modulator 10a includes an SPC (serial-to-parallel converter) 11a for outputting an input bit stream through two signal paths; multipliers 12a, 13a for generating an I signal and a Q signal by multiplying a bit stream output from the SPC 11a by a sinω t and cosω t respectively; a peak clipping circuit 14a for controlling a peak level of I and Q signals output from the multipliers; and a connecting circuit 15a for combining the peak-level restrained I and Q signals.

Operation of the conventional multi-carrier transmitter will now be described. When a bit stream generated by sampling and quantization is inputted, the bit stream is delivered to multipliers 12a, 13a through the SPC 11a of the modulator 10a. The multipliers generate I and Q signals by respectively multiplying the bit stream output from the SPC 11a by sinω t and cosco t respectively. The peak clipping circuit limits a peak level of the I and Q signals output from the multipliers according to a control signal output from a CPU (not shown), and the peak-level limited I and Q signals are combined in the connecting circuit 15a. The other modulators shown perform the same operation. Multiplexing circuit 20 multiplexes the output signal of the plural modulators 10a˜10n, and power amplifier 30 amplifies the multiplexed signal and transmits it to the antenna.

FIG. 2 is a block diagram illustrating an example of the peak clipping circuit 14a. This circuit consists of a clipping level generator 40 an inverter 42 for reversing an output of the clipping level generator 40, first and second comparators 44a, 44b, and first and second selectors 46a, 46b.

The clipping level generator generates clipping levels (IC, QC) according to the control signal output from the CPU (not shown), and the clipping levels (IC, QC) are displayed as the same bit length with the I and Q signals.

The first comparator 44a outputs a comparison result signal (CSI) by comparing a level of the I signal output from the multiplier 15a with the clipping levels (IC,-IC). Accordingly, the first selector 46a selectively outputs one of the I signal and the clipping level signals (IC,-IC) according to the comparison result signal (CSI). Specifically, if a level of the I signal exists between the clipping levels (IC,-IC), the first selector 46a outputs the I signal. On the other hand, if a level of the I signal exceeds the clipping levels (-IC), the first selector 46a outputs the clipping level (IC). If a level of the I signal is less than the clipping level signal (-IC), the first selector 46a outputs the clipping level signal (-IC).

More specifically, if the absolute value of the I signal is less than the clipping level (IC), the first selector 46a outputs the I signal. If the absolute value of the I signal is greater than the clipping level (IC), the first selector 46a outputs the clipping level (IC).

As described above, if a level of the input signal (I, Q) is greater than a clipping level, the peak clipping circuit unconditionally performs clipping of the input signal (I, Q) and outputs it. In addition, the peak clipping circuit divides an input signal into I and Q channels for comparison. Occasionally, a Q signal is greater than a clipping level and an I signal is less than the clipping level. In that case, although the Q signal is greater than the clipping level, because the total power is small, there is no need to perform clipping of the Q signal.

In the peak clipping circuit of FIG. 1, because clipping of the input signal (I, Q) is performed only with a clipping level regardless of power, unnecessary distortion of the input signal may occur and the signal distortion may deteriorate characteristics of the power amplifier.

In addition, in this peak clipping circuit, if the absolute value of the input signal (I, Q) is less than a clipping level, the input signal is outputted as it is. If a level of the input signal (I, Q) is not particularly great, it may lower output efficiency of the power amplifier. In that case, in order to improve output efficiency of the power amplifier, there is a need to increase a gain of the input signal appropriately. However, the peak clipping circuit of FIG. 1 cannot perform an AGC (automatic gain control) function.

More specifically, the peak clipping circuit can perform an ALC (automatic level control) function. However, it cannot provide the AGC function, and accordingly output efficiency of the power amplifier cannot be appropriately maintained.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

It is an object of the present invention to provide a multi-carrier transmitter having an ALC (automatic level control) function and an AGC (automatic gain control) function.

It is another object of the present invention to provide an output level adjusting circuit and a method thereof for a multi-carrier transmitter which adjust a level of a multi-carrier signal using an average power of the multi-carrier signal.

It is another object of the present invention to provide an output level adjusting circuit and a method thereof for a multi-carrier transmitter which selectively decreases and increases a level of a multi-carrier signal by comparing a peak-to-average ratio (PAR) of the multi-carrier signal with a target PAR.

In order to achieve the above-mentioned objects, an output level adjusting method of a multi-carrier transmitter in accordance with the present invention includes calculating a PAR (peak to average ratio) of a multi-carrier signal, comparing the calculated PAR with a target PAR, and controlling a level of the multi-carrier signal according to the comparison result. ALC is performed when the calculated PAR is less than the target PAR, and AGC is performed when the calculated PAR is greater than the target PAR.

The level controlling step includes the sub-steps of attenuating the multi-carrier signal as much as a pertinent PAR when the calculated PAR is less than the target PAR, and increasing a gain of the multi-carrier signal as much as a difference between average power and target power when the calculated PAR is greater than the target PAR.

An output level adjusting circuit of a multi-carrier transmitter in accordance with the present invention includes an average power measuring unit for measuring average power of a multi-carrier signal a PAR calculator for calculating a PAR (peak to average ratio) of the multi-carrier signal using the measured average power, a level controller for outputting a control signal by performing an ALC (automatic level control) and an AGC (automatic gain control) selectively according to the comparison result, and a signal level adjuster for adjusting a level of the multi-carrier signal according to the control signal. The attenuator is operated when the calculated PAR is less than the target PAR and outputs an attenuation signal corresponded to the calculated PAR. The gain controller is operated when the calculated PAR is greater than the target PAR and outputs a gain signal corresponded to difference between average power and target power of the multi-carrier signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a related art multi-carrier transmitter;

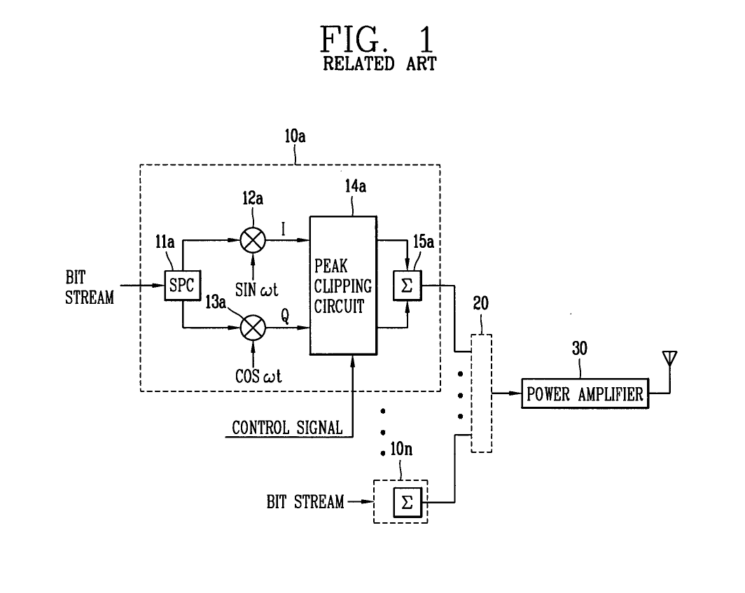

FIG. 2 is a block diagram illustrating a peak clipping circuit in FIG. 1;

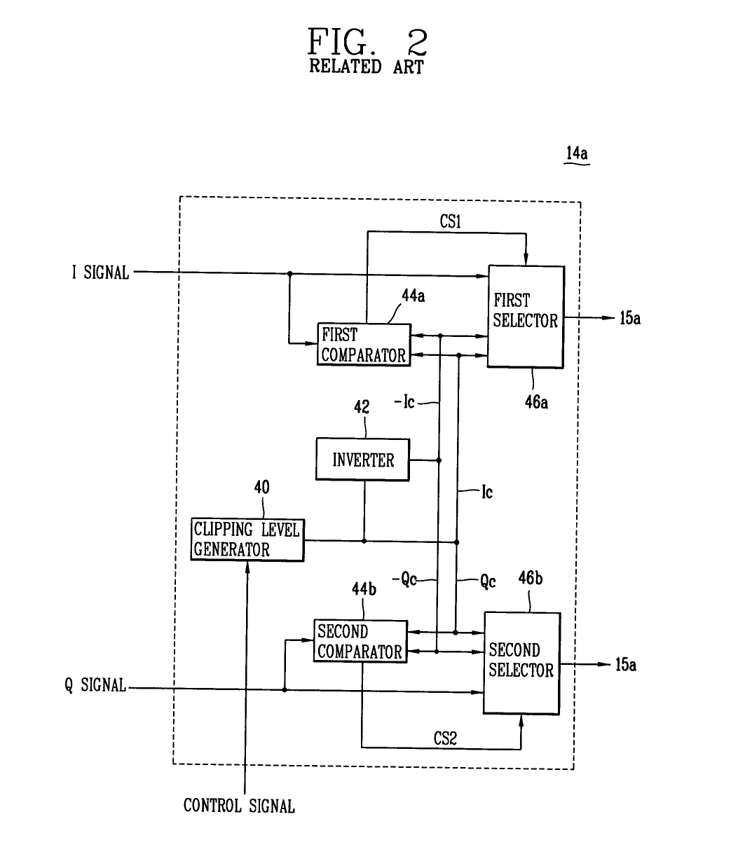

FIG. 3 is a block diagram illustrating an output level adjusting circuit of a multi-carrier transmitter in accordance with the present invention; and

FIG. 4 is a flow chart illustrating an output level adjusting method of a multi-carrier transmitter in accordance with the present invention.

### DETAILED DESCRIPTION OF PREFERRED EMBODIMENTS

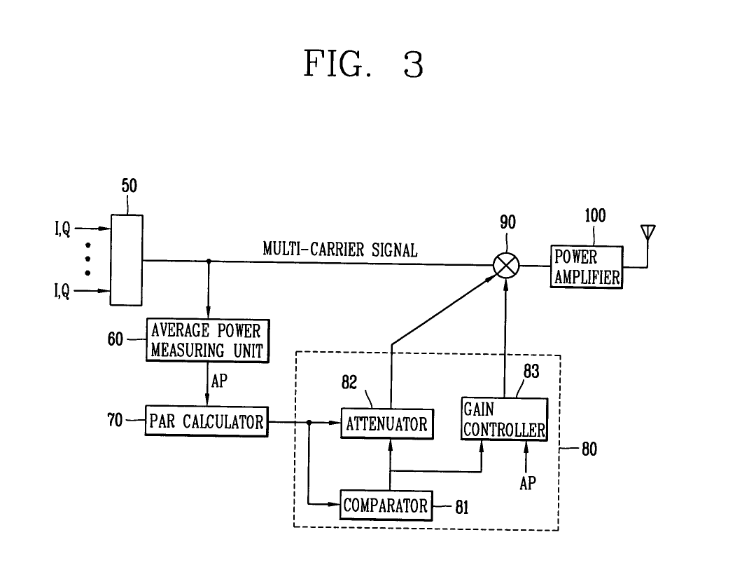

FIG. 3 is a block diagram illustrating an output level adjusting circuit of a multi-carrier transmitter in accordance with one embodiment of the present invention. This circuit includes a multi-carrier combiner 50, an average power measuring unit 60, a PAR calculator 70, a level controller 80, a signal level adjuster 90, and a power amplifier 100. The multi-carrier combiner combines multi-channel digital inputs (I, Q) of a multi-carrier transmitter with each other. The average power measuring unit 60 measures AP (average power) of a multi-carrier signal output from the multi-carrier combiner. The PAR calculator 70 calculates a PAR (peak to average ratio) of the multi-carrier signal using the measured AP. The level controller 80 performs ALC and AGC selectively according to a comparison result between the calculated PAR and a target PAR, and outputs a control signal. The signal level adjuster 90 adjusts a level of the multi-carrier signal according to the control signal of the level controller 80. And, the power amplifier 100 amplifies the level-adjusted multi-carrier signal and outputs it to the antenna. The signal level adjuster 90 may be constructed, for example, as a multiplier.

The level controller 80 includes a comparator 81 for comparing the calculated PAR with the target PAR, an attenuator 82 for outputting an attenuation signal corresponded to a pertinent PAR when the calculated PAR is less than the target PAR, and a gain controller 83 for outputting a gain signal corresponded to a difference between the AP and the target power of the power amplifier 100 when the calculated PAR is greater than the target PAR.

In the level controller, in order to prevent an output of the power amplifier from being operated in a saturation region due to an excessive-sized multi-carrier signal attenuator 82 performs the ALC function for attenuating a size of the input signal to a certain level, in order to prevent output efficiency of the power amplifier from being lowered due to a small-sized input signal. The gain controller 83 performs the AGC function for increasing a gain of the input signal to a certain level.

Operation of the output level adjusting circuit of the multi-carrier transmitter in accordance with the present invention will be described with reference to accompanying drawings. The multi-channel digital signals (I, Q) become a multi-carrier signal by being combined with each other in the multi-carrier combiner 50. The average power measuring unit 60 measures the AP (average power) of the multi-carrier signal, and the PAR calculator 70 calculates a difference between a maximum power (Pmax) of the power amplifier 100 and the AP, namely, PAR of the multi-carrier signal.

The level controller 80 compares the calculated PAR with the target PAR, performs the ALC function or the AGC function selectively and outputs an attenuation signal or a gain signal for controlling a level of the multi-carrier signal. More specifically, the comparator 81 compares the PAR with the target PAR. When the calculated PAR is less than the target PAR, the comparator 81 outputs a low level comparison signal. When the calculated PAR is greater than the target PAR, the comparator 81 outputs a high level comparison signal. Based on the comparison signal output from the comparator 81, the attenuator 82 or the gain controller 83 is selectively operated.

If the calculated PAR is less than the target PAR, (e.g., an output of the power amplifier is operated in a saturation region due to an excessive-sized multi-carrier signal), the attenuator 82 is operated by a lower-level comparison signal and outputs an attenuation signal corresponding to the calculated PAR value. Herein, the operation of the gain controller 83 is stopped. Accordingly, the signal level adjuster 90 attenuates a level of the multi-carrier signal as much as the attenuation signal outputted from the attenuator 82. As a result, output distortion of the power amplifier due to the excessive multi-carrier signal can be prevented.

If the calculated PAR is greater than the target PAR, (e.g., an output of the power amplifier does not reach a maximum output (there is margin for a maximum output)), the gain controller 83 is operated by a high-level comparison signal and outputs a gain signal corresponding to a difference between the AP and the target power. Herein, the operation of the attenuator 82 is stopped.

Accordingly, the signal level adjuster 90 increases a level of the multi-carrier signal as much as the gain signal outputted from the gain controller 83. As a result, it is possible to prevent output efficiency of the power amplifier from being lowered due to the small-sized multi-carrier signal.

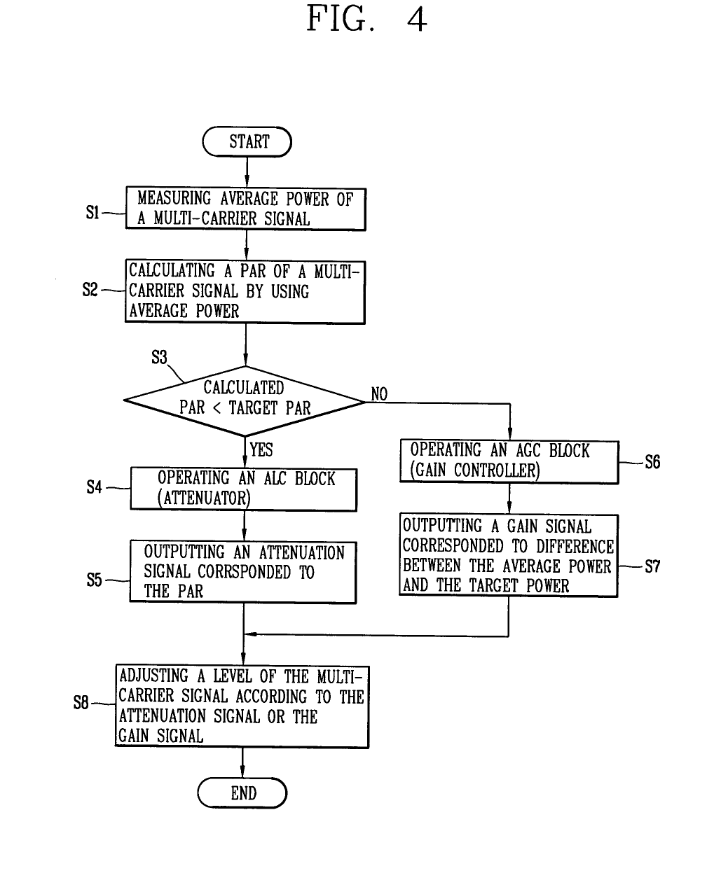

An output level adjusting method of the multi-carrier transmitter in accordance with the present invention will be described with reference to accompanying FIG. 4.

First, the output level adjusting circuit of the multi-carrier transmitter measures the AP of the multi-carrier signal as shown at step S1 and calculates a difference between the measured AP and the maximum power (Pmax) of the power amplifier 100, namely a PAR (peak to average ratio) as shown at step S2.

When the PAR of the multi-carrier signal is calculated, the output level adjusting circuit checks whether the calculated PAR is less than the target PAR as shown at step S3. In the check result, when the calculated PAR is less than the target PAR, the output level adjusting circuit regards the output of the power amplifier 100 to be operating in a saturation region, and accordingly an attenuation signal is output as the calculated PAR by operating the ALC block (attenuator), as shown at steps S4 and S5.

When the calculated PAR is greater than the target PAR, the output level adjusting circuit operates the AGC block (gain controller) in order to increase output efficiency of the power amplifier 100 and outputs a gain signal corresponding to the difference between the average power (AP) and the target power (TP), as shown at steps S6 and S7.

Accordingly, the output level adjusting circuit adjusts a level of the multi-carrier signal according to the attenuation signal or the gain signal outputted from the ALC block or the AGC block.

As described above, the output level adjusting circuit of the multi-carrier transmitter can prevent distortion due to the excessive multi-carrier signal in the saturation region of the power amplifier using the ALC function and can maintain a gain of the multi-carrier signal using the AGC function. Accordingly, output efficiency of the power amplifier is substantially improved.

Also in accordance with the present invention, after calculating a PAR of a multi-carrier signal using average power of the multi-carrier signal and performing an ALC operation or an AGC operation selectively based on a comparison result between the pertinent PAR and a target PAR, a level of the multi-carrier signal can be efficiently adjusted. In the result, output efficiency of a power amplifier is improved by the appropriately adjusted multi-carrier signal. Accordingly reliability of the multi-carrier transmitter is substantially improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An output level adjusting method of a multi-carrier transmitter, comprising:
calculating a PAR (peak to average ratio) of a multi-carrier signal;
comparing the calculated PAR with a target PAR; and
controlling a level of the multi-carrier signal based on a result of the comparison.

2. The method of claim 1, wherein the level controlling step includes:
attenuating the multi-carrier when the calculated PAR is less than the target PAR; and
increasing a gain of the multi-carrier signal when the calculated PAR is greater than the target PAR.

3. The method of claim 1, wherein the multi-carrier signal is attenuated in accordance with the calculated PAR.

4. The method of claim 1, wherein a gain of the multi-carrier signal is increased based on a difference between average power and target power.

5. An output level adjusting method of a multi-carrier transmitter, comprising:
calculating a PAR (peak to average ratio) of a multi-carrier signal;
comparing the calculated PAR with a target PAR; and
controlling a level of the multi-carrier signal by selectively performing one of an ALC (automatic level control) and an AGC (automatic gain control) based on a result of the comparison.

6. The method of claim 5, wherein the ALC is performed when the calculated PAR is less than the target PAR.

7. The method of claim 5, wherein the AGC is performed when the calculated PAR is greater than the target PAR.

8. The method of claim 5, wherein the level controlling step includes:
attenuating the multi-carrier signal in accordance with a pertinent PAR when the calculated PAR is less than the target PAR; and
increasing a gain of the multi-carrier signal based on a difference between average power and target power when the calculated PAR is greater than the target PAR.

9. An output level adjusting circuit of a multi-carrier transmitter, comprising:
an average power measuring unit which measures an average power of a multi-carrier signal;
a PAR calculator which calculates a PAR (peak to average ratio) of the multi-carrier signal based on the measured average power;
a level controller function which selectively performs one of an ALC (automatic level control) function and an AGC (automatic gain control) function based on the calculated PAR; and
a signal level adjuster which adjusts a level of the multi-carrier signal based on a control signal generated from the selected function performed by the level controller.

10. The circuit of claim 9, wherein the calculated PAR is obtained by subtracting average power from a maximum power of a power amplifier.

11. The circuit of claim 9, wherein the level controller includes:
an attenuator which attenuates the multi-carrier signal to a certain level;
a gain controller which increases a gain of the multi-carrier signal; and
a comparator which outputs a comparison signal for selectively operating the attenuator and the gain controller after comparing the calculated PAR (peak to average ratio) with a target PAR.

12. The circuit of claim 11, wherein the attenuator is operated when the calculated PAR is less than the target PAR, and the gain controller is operated when the calculated PAR is greater than the target PAR.

13. The circuit of claim 11, wherein the attenuator outputs the control signal in the form of an attenuation signal corresponding to the calculated PAR.

14. The circuit of claim 11, wherein the gain controller outputs the control signal in the form of a gain signal corresponded to a difference between the measured average power and a target power of the multi-carrier signal.

15. An output level adjusting circuit of a multi-carrier transmitter, comprising:
an average power measuring unit which measures an average power of a multi-carrier signal;
a PAR calculator which calculates a PAR (peak to average ratio) of the multi-carrier signal using the measured average power;
an attenuator which attenuates the multi-carrier signal;
a gain controller which increases a gain of the multi-carrier signal;
a comparator which outputs a comparison signal for selectively operating the attenuator and the gain controller after comparing the calculated PAR (peak to average ratio) with a target PAR; and
a multiplier which adjusts a level of the multi-carrier signal based on an output signal of the selected one of the attenuator and the gain controller.

16. The circuit of claim 15, wherein the PAR of the multi-carrier signal is obtained by subtracting the average power from a maximum power of the power amplifier.

17. The circuit of claim 15, wherein the attenuator is operated when the calculated PAR is less than the target PAR, and the gain controller is operated when the calculated PAR is greater than the target PAR.

18. The circuit of claim 15, wherein the attenuator outputs an attenuation signal corresponding to the calculated PAR, and the gain controller outputs a gain signal corresponding to difference between the average power and the target power of the multi-carrier signal.

19. A method for controlling a multi-level transmitter, comprising:
calculating a power value of a multi-carrier signal of the transmitter; and
controlling a level of the multi-carrier signal based on the calculated power value.

20. The method of claim 19, wherein the controlling step includes:
increasing the level of the multi-carrier signal based on the calculated power value.

21. The method of claim 20, wherein the increasing step includes:
increasing the level of the multi-carrier signal by increasing a gain of a power amplifier of the transmitter.

22. The method of claim 19, wherein the controlling step includes:
comparing the calculated power value to a reference power value; and
increasing a gain of the multi-carrier signal based on a result of the comparison.

23. The method of claim 22, wherein increasing the gain of the multi-carrier signal is performed when the calculated power value is greater than the reference power value.

24. The method of claim 19, wherein the controlling step includes:
comparing the calculated power value to a reference power value; and
attenuating the multi-carrier signal based on a result of the comparison.

25. The method of claim 24, wherein the attenuating step is performed when the calculated power value is less than the reference power value.

26. The method of claim 19, wherein the calculated power value is a peak-to-average ratio (PAR) of the multi-carrier signal.

27. The method of claim 26, further comprising:
calculating the PAR based on a difference between a measured average power of the multi-carrier signal and a reference power.

28. The method of claim 27, wherein the reference power is based on a maximum power of a power amplifier of the transmitter.

29. A controller for a transmitter, comprising:
a detector which detects a power value of a multi-carrier signal of the transmitter; and
a processor which adjusts a level of the multi-carrier signal based on the power value.

30. The controller of claim 29, wherein the processor increases the level of the multi-carrier signal based on the power value.

31. The controller of claim 30, wherein the processor increases the level of the multi-carrier signal by increasing a gain of a power amplifier of the transmitter.

32. The controller of claim 29, wherein the detector includes a comparator which compares the power value to a reference power value, and wherein the processor increases a gain of the multi-carrier signal based on a result of the comparison.

33. The controller of claim 32, wherein the processor increases the gain of the multi-carrier signal when the power value is greater than the reference power value.

34. The controller of claim 29, wherein the detector includes a comparator which compares the power value to a reference power value, and wherein the processor attenuates the multi-carrier signal based on a result of the comparison.

35. The controller of claim 34, wherein the processor attenuates the multi-carrier signal when the calculated power is less than the reference power value.

36. The controller of claim 29, wherein the power value is a peak-to-average ratio (PAR) of the multi-carrier signal.

37. The controller of claim 36, wherein the detector includes:
a calculator which calculates the PAR based on a difference between a measured average power of the multi-carrier signal and a reference power.

38. The controller of claim 37, wherein the reference power is based on a maximum power of
